(19) United States
(12) Patent Application Publication
(10) Pub. No.: US 2003/0061606 A1
(43) Pub. Date: Mar. 27, 2003

(54) Method and apparatus for inhibiting functions of an electronic device according to predefined inhibit rules

(76) Inventors: Stephan Hartwig, Essen (DE); Botteck Martin, Dortmund (DE)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/956,910

(22) Filed: Sep. 21, 2001

(51) Int. Cl. H04N 7/16; H04B 1/06; H04K 1/00; H04N 5/44

(52) U.S. Cl. 725/25; 380/270; 455/26.1; 348/734

(57) ABSTRACT

A method and apparatus to inhibit or unlock functions of a device using predefined inhibit rules. The inhibit rules are transmitted to the device to be access limited by an authorized mobile remote control means. To define the inhibit rules a markup language content server may be included in the controlled device and a corresponding client may be included in the mobile remote control means which communicates via a wireless interface with the device to be controlled. Preferably a low power radio frequency interface is employed. The inhibit rule comprises different sub-rules like an account of a period of time, cost account, access time limitation, number of the accesses or the like. Modifying access to the inhibit rules can be limited to authorized control devices by way of Bluetooth link keys and passkeys.

### BACKGROUND OF THE INVENTION

The present invention relates to a method and apparatus for inhibiting or locking access to an electrical or electronic device. Particularly, the present invention relates to a method and apparatus to inhibit access to single parts and/or functions of an electrical device to enable e.g. parents or supervisors to control and limit time spent with this device parts and/or functions. Also, other inhibit rules can be set like cost, number of accesses, period of time and the like in order to not only limit the access but also achieve an educational effect.

The parental control of the amount of time children spend in front of television sets was the subject of an extensive discussion years ago. Today, not only the control of television sets but also the control of game devices are in discussion and the problems associated therewith still result unsolved. The reduction of time spent with this kind of spare time entertainment in the household is known or believed to promote the development of the children and improve the social behavior and increases social contacts in the family and to other children. The problem with game devices increases with regard to the circumstances that more and more mobile devices comprise additional features, especially game devices, which can be accessed by modern mobile devices.

Disabling of the whole device as was done in early times when television was established is not desirable or not practical. Also, parental directives are hardly enforceable during parental absence. Particularly, devices with embedded game facility, like mobile phones shall not be locked away due to desired functional elements like the phone unit which are maintained preferably active to the children in order to be able to contact parents in case of dangerous situations.

Several patents disclose inhibiting devices to inhibit or unlock the use of devices like television sets. Such devices comprise commonly means to disable the whole device. Operation of such specific inhibiting devices is often difficult for children and incorrect operation of the inhibiting devices can lead to undesired misunderstandings. Chip cards and comparable devices enable to identify the user and therefore to give or to refuse the permission of usage. They can be overridden by use of hacked chip cards easily available or by use of the parent's chip card stored somewhere and not effectively hidden in the household.

Deployment of electronic key systems stored locally in the device suffers generally from sustainable security since the actual user of the device spends typically much more time with the device than the supervisor. Consequently, he/she has much better opportunity to break the access rules than the supervisor has to maintain their viability.

Nevertheless, none of prior inhibiting devices allows the specific control of devices or embedded devices to be controlled as desirable.

### SUMMARY OF THE INVENTION

Therefore, there is a need for a secure method and apparatus to limit and to survey the access of users to certain devices. By using the mobile remote control means, access limits and inhibit rules, respectively, are defined to be carried out in case of the use of the device by the user whose usage shall be controlled. The access limitation rules can be defined by employing different inhibit rules, like an account of a period of time, valid access times, access limitation of and by sub-functions and the like. The access to the inhibit rules has to be limited to a certain mobile remote control means in order to provide an effective and trustworthy definition procedure. An unsecured access to the inhibit rule definition would jeopardize the whole virtue of the present invention. Therefore, the mobile remote control means has to be authenticated.

The functions of a device are inhibited according to the method and apparatus of the present invention. A mobile remote control means is used to inhibit the functions of a device wherein the necessary data are transmitted via a wireless interface. A controller controls the plurality of functions of the device. In a first step the mobile remote control means has to be authenticated in order to establish a valid access protection. Thereafter, the inhibit rule data are transmitted from the mobile remote control means to the device using the ability of communicating via the wireless interfaces. According to the inhibit rule data certain functions of the device are inhibited or unlocked according to the definitions contained in the transmitted inhibit rule data. That means that inhibited functions are no longer operable by the controller of the device whereas unlocked functions are operable thereby. A user accessing the device and operating the device by operating the device functions via the controller can only operate unlocked functions. The authentication of the mobile remote control means can be performed in a first access step wherein the controller checks the access permission of the mobile remote control means. Alternatively, the authentication of the mobile remote control means can also be checked during each transmission of inhibit rules from the mobile remote control means to the controller. Therefore, it is possible to include a authenticating sequence in the inhibit rule to ensure that the submission thereof is originated from a valid mobile remote control means.

Conveniently, certain device functions can be realized as an executable software program or a part thereof in case of a device able to execute software programs. This function realized as executable software code can also be inhibited or unlocked according to transmitted inhibit rule data.

Additionally, the device preferably comprises a content server in order to provide an adequate user interface to transmit data from the mobile remote control means to the device. Of course, the content server can also serve as an information server transmitting first data according to the device and the functions thereof to the mobile remote control means since the wireless interfaces are operable bidirectionally, i.e. transmitting from the mobile remote control means to the device and vice versa is envisaged. The mobile remote control means has to comprise a corresponding client in order to enable the communication with the respective content server. More preferably, the content server is employed for transmitting the inhibit rule data from the mobile remote control means to the device. The inhibit rule data constitutes a user interface to allow the client to invoke the inhibit methods offered by the device.

Conveniently, the content server is based on markup language content of type hypertext markup language (HTML), extended hypertext markup language (XHTML), extensible markup language (XML) or wireless markup language (WML). These content servers are the currently usually operated content servers. Any content server operating related services can be employed in the same manner and are possible to be employed as well as the mentioned ones.

Preferably, the wireless interface is a low power radio frequency or just one embodiment of a wireless interface. Low power radio frequency interfaces are preferred interfaces due to the simple operation conditions for the user. The Bluetooth standard describes one certain low power radio frequency interface. Another one is the wireless local area network (WLAN) interface also defined by an international standard. Interfaces of the type are advantageous solutions for an embodiment according to the present invention. Additionally, the wireless communication between the device and the mobile remote control means can be based on standardized infrared (IRDA) interfaces but also proprietary ones.

More preferably, protocols suited for the transmission of markup hypertext language, like the hypertext transfer protocol (HTTP) or the transmission control protocol/internet protocol (TCP/IP) stack or the wireless application protocol (WAP) stack, are transmitted over the low power radio frequency interface, particularly transmitted over the Bluetooth interface or the WLAN interface, respectively. The use of protocols and corresponding protocol stacks depends on the type of applied wireless interfaces and has to be arranged according to the ability of the respective interface. Corresponding protocols and protocol stacks are available for all types of wireless interfaces and therefore the invention is not limited to low power radio frequency interfaces.

Additionally, the communication link between mobile remote control means and device of which functions may be inhibited or unlocked may be secured. Keys may be employed to secure communication links and enable additionally the authentication of the remote control means at the same time.

Conveniently, in case of using Bluetooth interfaces a Bluetooth key can be employed to authenticate the mobile remote control means and accept submitted inhibit rules therefrom. The usage of a Bluetooth key may enable to establish a secured communication link between the mobile remote control means and the device of which functions may be inhibited or unlocked according to the inhibit rules. A Bluetooth passkey may be a possible implementation of a secured Bluetooth communication link. This implies that only mobile remote control means knowing the passkey of the device of which functions may be inhibited or unlocked are actually allowed to establish a connection. The passkey of the device can be communicated to the purchaser by various means, e.g. on a removable label or in the printed manual. Supervisors have to store it in a safe place. Furthermore, Bluetooth IDs may be utilized to authenticate the data being communicated, however, these Bluetooth IDs are transmitted in clear during connection establishment and can thus be monitored with suitable equipment.

Preferably, the inhibit rule data comprises a predetermined access time. This access time defines a valid time at which the certain defined functions of the device are unlocked and inhibited, respectively. More preferably, the inhibit rule data comprises a predetermined period of time. Accordingly, the period of time defines a period in which certain defined functions of the device are unlocked or inhibited. A time account can be kept in order to protocol the period of time during which the device functions are used. At a certain time account level the respective functions of the device are inhibited. According to the inhibit rule data the time account can be reset after a predefined period for example after a day, a week or a month.

Additionally, the inhibit rule data can define a valid number of accesses to certain functions of the device. If the number of accesses is exceeded the functions get inhibited.

More additionally, the inhibition can be determined using additionally provided data. These data comprise an identification and/or classification code with is passed over to the controller. According to the inhibit rule data device functions are inhibited in case of certain identification and/or classification codes. Digital video broadcasts (DVB) television signals include entitlement messages (EMM) which contain among other television movie related information standardized age relating data and are decoded by the corresponding digital receiver units or devices. Including age relating data or other television related data allow to define precise and sensible inhibit rules. This is an existing embodiment of such an identification and/or classification code. Particularly, digital storage media like digital versatile disks (DVD) offer the opportunity to employ comparable movie related information and to use these rating data in combination with an embodiment according to the method of the present invention.

More conveniently, predetermined cost information can also be used to inhibit functions of the device. Comparable to the accounting of the period of time a cost account can be employed to inhibit or unlock the functions.

Preferably, data concerning the use of the functions which can be inhibited or unlocked are retransmitted to the mobile remote control means. This can be done by embedding an additional logging unit which stores the use of the functions and transmits the stored data on a request of the mobile remote control means or to any other authorized device.

### BRIEF DESCRIPTION OF THE DRAWINGS

Throughout the following, reference numerals will be used in the drawings, and like reference numerals will be used throughout the several figures in the description to describe corresponding parts of embodiment of the invention:

FIG. 1 shows a typical arrangement of a connected video recorder or a player for digital versatile discs (DVD) connected to a television set equipped with a Bluetooth interface and controlled by a mobile phone also comprising a Bluetooth interface and permitted to set the access limits and parameters,

FIG. 2 shows embedded units of the television set used for monitoring, controlling and logging access to the television set and different device connectors,

FIG. 3 shows an arrangement of two mobile phones both equipped with a Bluetooth interface, wherein mobile phone is authorized to set the access limits and access parameters of mobile phone,

FIG. 4 shows embedded devices of the mobile phone for monitoring, controlling and logging access to the mobile phone and the embedded functions.

FIG. 5a shows an arrangement of game devices and a mobile phone transmitting game related data to each other via a low power radio frequency connections using Bluetooth interfaces, and

FIG. 5b shows an arrangement of game devices and mobile phones transmitting game related data to each other via a wide area communication network or a low power radio frequency connection using Bluetooth interfaces.

### DETAILED DESCRIPTION OF THE PREFERRED EMBODIMENT

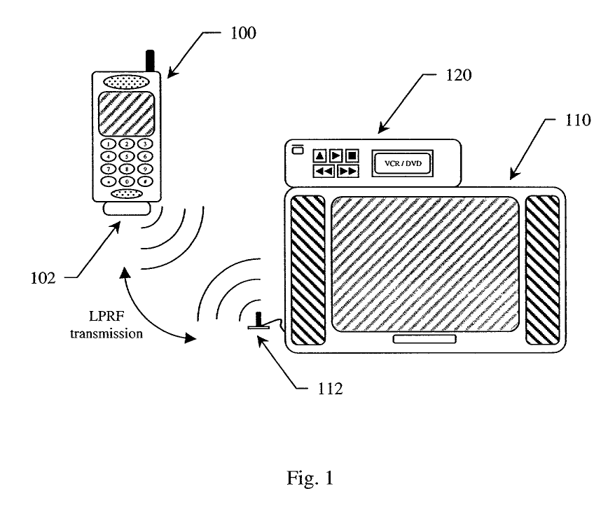

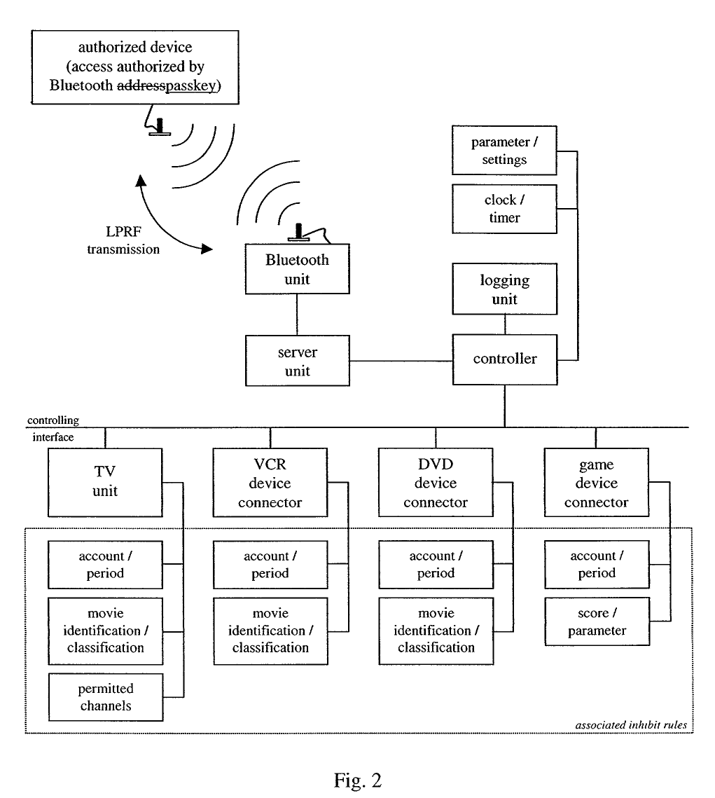

In the following FIG. 1 and FIG. 2 show a first embodiment of the present invention controlling the access of a television set. In particular, this control is intended with regard to restrain the use of the television set and additionally connected home electronic devices by children in absence of parental supervision.

FIG. 1 shows a typical arrangement of a television set 110 and a connected video recorder (VCR) 120 or digital versatile disc player (DVD) 120. The television set is equipped with a inhibiting device able to operate a first embodiment of the present invention. To communicate with the authorized mobile remote control means, herein a mobile phone 100 both the television set 110 and the mobile phone 100 are equipped with a low power radio frequency (LPRF) interfaces, herein the Bluetooth interface 112, 102.

FIG. 2 shows a first preferred embodiment of a inhibiting device embedded in a television set 110 which enables to inhibit or unlock the access of the television set and related devices according to predefined inhibit rule data. Therefore, the television set is equipped with several units. To enable control of the television set 110 according to the method of the present invention at least a unit for receiving data, herein a Bluetooth interface 112, via a low power radio frequency connection and a controller connected to the television unit via a controlling interface is necessary. Additional depicted units such as a server unit, a logging unit, and further controlled device connectors for external devices are desirable.

An external mobile remote control means, herein a mobile phone 100, equipped also with a corresponding low power radio frequency interface, herein a Bluetooth interface 102, connects to the embedded inhibiting device. The connection to the inhibiting device is only allowed to authorized devices which have to be declared to the inhibiting device when the device is put into operation the first time. A possible identification method employs the usage of the unique Bluetooth address but also other unique identification sequences can be employed which are transmitted via the Bluetooth connection to the inhibiting device to gain access to the configuring level. Another possibility is to use the pairing procedure defined in Bluetooth. This preferred embodiment comprises a server unit for communicating with the mobile phone 100. Conveniently, the mobile phone 100 has to comprise a corresponding client. Actually, most modern mobile phones comprise a wireless application protocol (WAP) client to access special internet WAP servers. Embedding a WAP server and using WAP over Bluetooth capability is a advantageous way. But also a standard WEB server with corresponding client can be used. According to the capability of the server unit and the client, different markup languages can be applied such as hypertext markup language (HTML), extended hypertext markup language (XHTML), wireless markup language (WML), extensible markup language (XML), being transmitted via different protocol stacks like the WAP wireless protocol stack or the HTTP/TCP/IP stack (hypertext transfer protocol, transmission control protocol/internet protocol). The server unit transmits for example WAP decks, i.e. a set of WAP pages, in order to describe the built-in capabilities of the inhibiting device and to offer an adequate user interface to configure fast and effectively the inhibiting device. According to the capabilities of the WAP client of mobile phone 100 a wireless markup language (WML) script or a Java Applet application can be transmitted additionally generating an encryption key in order to encrypt the transmitted control rules. In this case the server has to execute a corresponding script to evaluate the related key to decrypt the transmitted information. This additional transmission protection prevents the modification of transmitted information and secures the data exchange via the low power radio frequency connection.

Different kinds of inhibit rules or access limiting conditions can be set according to the capabilities and desires, respectively. These different inhibit rules will be discussed below in accordance with the description of the different connected units and devices. In order to control the different desired and defined devices and units according to the inhibit rules defined using the server unit the controller has to comprise different sub-units like a clock or timer, a sub-unit to store the control conditions and settings, a sub-unit to store time account information. These sub-units can be embedded directly in the controller but also be connected to this controller since sub-units like clock and timer are already implemented in other units of the television set.

A most obvious example for realizing this invention is a TV unit. The simplest kind of access control is to permit or to inhibit the total usage of the television unit. An educational effect will not be reached easily and the education of independent behavior will not be promoted. It can be better to keep an account of a period of time that defines the time which can be spent by television watching per day, week, month or another predefined period. The surveillance of watched television programs and the kind of programs watched during the permitted period of time is not possible. Therefore, it is desirable to define additional valid times during which the use of the television unit is permitted e.g. to inhibit the use after 8 p.m. Further the permission of use of the television unit can be limited to a selected number of television channels. Of course these different limiting conditions can be combined to a complex definition of television unit use permission. The resulting television use pattern limits for example children's time spent for television watching but also enables to educate children to decide themselves how to use the permitted time account during the permitted times without permitting the watch of late movies which often show violence. Further, it is possible to distinguish television movies by an additional simultaneously transmitted identification or classification code defining a recommended minimum age. For example, digital video broadcasts (DVB) television signals include entitlement massages (EMM) which contain among other television movie related information standardized age rating data and are decoded by the corresponding digital receiver units or devices. Including rage rating data or other television related data allow to define precise and sensible inhibit rules.

Television sets are today equipped with additional connectors to connect to home electronic devices like video recorders (VCRs), digital versatile disc players (DVD), or game devices. The access to these devices can be controlled directly by embedding suitable inhibiting devices which is expensive and the definition of the inhibit rules which is time-extensive. An easy approach to control these additionally connected devices is to control the respective connectors of these devices at the television set. Similar to the control of the television unit an account of a period of time can be kept to limit usage. This account can be a separate account in order to distinguish between the different devices, particularly, to limit game devices more restrictively or vice versa. A total prohibition of the use of VCR and DVD player and the like is of course possible if the control by using an account of a period of time seems not to be sufficient. Comparable to a possible movie identification or classification code submitted simultaneously during transmission of a television movie an identification or classification code implemented on DVD movies or video movies would allow to inhibit the use to a certain suitable selection of movies.

A logging unit can be connected to the inhibiting device as an optional unit to survey the use of the television set and connected external devices. This feature can be important for example if an account of a period of time is granted to children and the parents want to reconstruct the use of the television. The logging unit can protocol for example the time, period and channels selected during watching television. It is also possible to protocol the period of use of an external device. These logged results can be retrieved by the implemented server unit which can organize and submit them e.g. as WAP decks.

It is possible to define different inhibit rule patterns owing to different users if several users have access to the device. In case of inhibit rule pattern concerning different users, a user identification has to be implemented. According to the authorization method of the mobile remote control means employed for configuring the inhibiting device it makes sense if the users of the device are identified. This user identification should be carried out as secure as the remote control identification to prevent misuse by changing the identification of the user. A preferred user identification method would employ the same method used for identification of the permitted mobile remote control means. According to the above described embodiment of the controlled television set this would involve that each user has to identify himself by transmitting an identification sequence such as the Bluetooth address of his mobile phone via a Bluetooth interface to the controlled television set. In case of an unidentified user a default inhibit rule pattern can be used by the inhibiting device which is of course also configurable and is used in case of a single user device such as a television set in the children's room.

Especially, the implementation of a inhibiting device according to the above discussed method enables additional communication possibilities which can be employed by game devices. Game parameters like score, situation describing parameters or game conditions can be transmitted via the Bluetooth interface. The dual use of the inhibiting device not only to control the access but also to transceive parameters and data from and to the connected devices and units is advantageous.

The embodiment uses a mobile phone 100 as mobile remote control means to configure the embedded inhibiting device. It is obvious that the usage of mobile phone as mobile remote control means is not limiting. The mobile remote control means only comprises a wireless communication interface in order to transmit inhibit rule data to the inhibiting device. Common devices like mobile terminals such as mobile computer or personal digital assistants (PDA) equipped with a corresponding interface are also possible for use. These devices also enable the possibility of implementing a server unit since corresponding clients are available for a multiplicity of mobile devices. Conveniently, low power radio frequency network is not limited to the described Bluetooth network standard. Other common standards like the wireless local area network (WLAN) standard and related wireless communication network standards like infrared (IRDA) interfaces are usable.

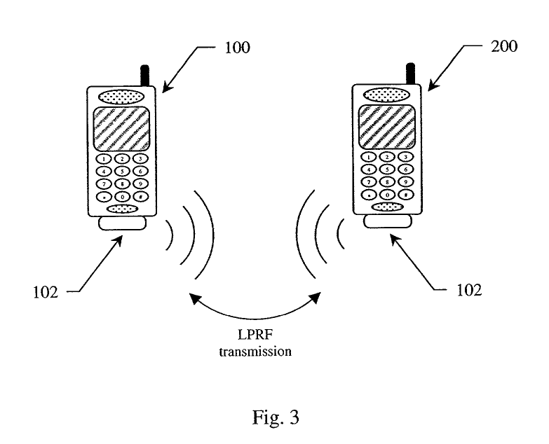

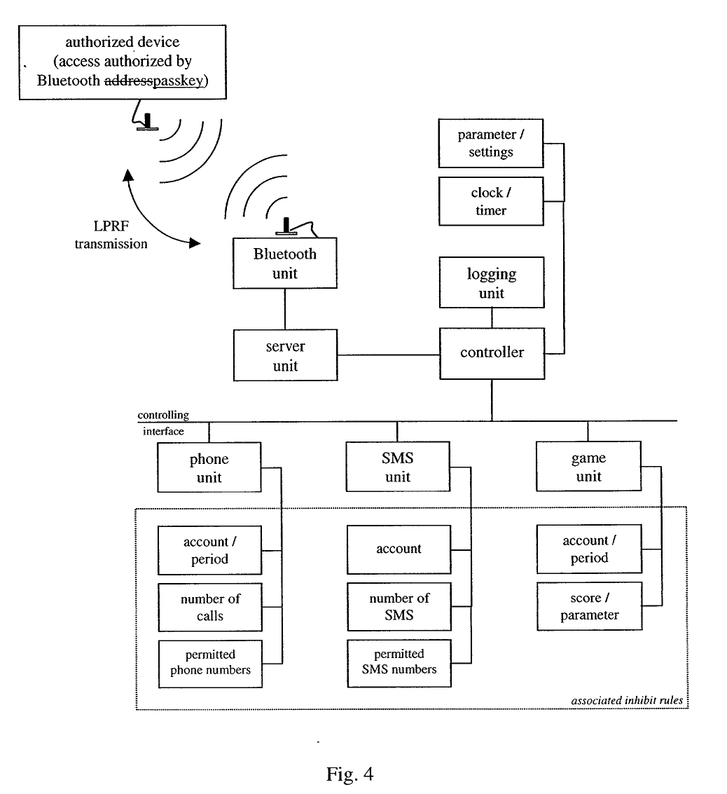

The following FIG. 3 and FIG. 4 show a further embodiment of the present invention controlling the usage and access of a mobile phone comprising embedded additional devices. The use of a mobile phone and the embedded units can be controlled. Prepaid cards can control the use of mobile phones but embedded units like a game unit are not limited by this kind of control system. Only services which have to be paid are subject to limitation. Even access limitation by prepaid cards can be undesired due to the fact that empty prepaid cards do not allow phone calls to certain numbers anymore, though the ability of phone calls to such numbers is desired in certain cases. Therefore, especially an adaptable inhibit rule inhibiting device can meet more objects of parental wishes.

FIG. 3 shows an arrangement of two mobile phones 100, 200 both equipped with Bluetooth interfaces 102 to communicate via a low power radio frequency (LPRF) link. According to this further embodiment of the present invention the mobile phone 100 is an authorized mobile remote control means to set the access rules of use of the mobile phone 200.

FIG. 4 shows a further arrangement of the inhibiting device and connected units embedded in the controlled mobile phone 200. Accordingly, the controlled phone 200 comprises a Bluetooth interface 102, a server unit and a controller which is connected to a phone unit, a short message service (SMS) unit and a game unit of this mobile phone 200.

An authorized mobile phone 100 equipped with a Bluetooth interface 102 is allowed to configure the inhibiting device of mobile phone 200. The authorization of mobile phone 100 for access to the inhibiting device can be done by employing the passkey of the inhibiting device or the mobile phone 200, respectively. 1h order to employ this authorization method the key sequence has to be declared during the first time of use of the mobile phone 100. For example, when mobile phone 200 including the inhibiting device is purchased passkeys can be provided in the sales kit. The passkeys may be used for generating link keys and for establishing secured communication links between the both mobile phones 100 and 200. The secured communication link between the mobile phones 100 and 200 comprise the validation of the used link key or the passkey, respectively, by mobile phone 200 or the inhibiting device included in mobile phone 200, respectively. Devices having matching link keys and are able to establish a secured communication link are called “bonded” or “paired” deceives, respectively. Moreover, keys may be used to sign digitally the inhibit rules, wherein the a corresponding keys may be applied for validation of connection establishment. Procedures for generating and validating digital signs are well known and used for example to digitally sign electronic mails. Further, the usage of keys provided with the device of which functions may be inhibited and/or unlocked enable the possibility to declare different mobile remote control means, such as mobile phone 100, as valid mobile remote control means which are allowed to define and transmit inhibit rules. A configuration defining valid mobile remote control means to the device of which functions may be inhibited or unlock may be not necessary and improves the access security to the inhibit rules. Of course, the provided keys may have to be kept secret since the keys may allow to declare suitable devices as trusted devices for defining and transmitting inhibit rules.

This embodiment comprises a server unit to communicate with the mobile phone 100 which comprises the corresponding client. According to the equipment of the most modern mobile phones a WAP server and a corresponding WAP client is preferable. WAP decks related to the inhibiting device functions are transmitted to the mobile phone 100 and the user of the mobile phone 100 can configure in an easy and fast way the access conditions and access rules of the mobile phone 200. According to the capabilities of the WAP client of mobile phone 100 a wireless markup language (WML) script or a Java Applet application can be transmitted additionally generating an encryption key in order to encrypt or sign digitally the transmitted inhibit rules. In this case the server has to execute a corresponding script to evaluate the related key to decrypt the transmitted information or validate the digital sign, respectively. This additional transmission protection prevents the modification of transmitted information and secures the data exchange via the low power radio frequency connection and offers the validation of the mobile remote control means. Different kind of access limitation can be configured according to the possibilities of the controlled unit of the mobile phone 200.

The phone unit of the mobile phone 200 can be controlled by monitoring the costs of the calls or the number of the calls per day, week, month or any other predefined period. An account defined by the configuration of the inhibiting device can be used to limit the access to the phone unit so that no calls can be effected any more. Similarly, the duration of time of a phone call or total phone calls during a certain period can be summarized and used for limiting purposes. It is also devisable to define a set of numbers which are accepted by the phone unit such that all other numbers are rejected. More interesting is the possibility of the control system to combine these presented inhibit rules to a inhibit rule pattern. For example, it is possible to use a cost account to limit the use of the phone unit but permit phone calls to predefined numbers even if the account value of the phone unit limits such use at the moment. Thus, it is guaranteed that e.g. a child can always contact his parents under certain circumstances.

Comparable inhibit rules can be utilized to control a SMS unit of the mobile phone 200. A cost account or the number of the transmitted SMS messages can be invoked. The permission of transmission can be restricted to a selected predefined set of numbers. The inhibit rules are combinable in the same manner as described for the phone unit. In order to limit access to a game unit of the mobile phone 200 an account of a period of time can also be employed.

An optional implementation of this embodiment comprises a logging unit which is connected to the controller of the inhibiting device. Due to the fact that the controller has to be connected to the controlled units the logging unit can be used to protocol the use of the single units. Even if the access to the single units is limited by inhibit rules it can be interesting to reconstruct the usage of these single devices in order to redefine the access rules or in order to recognize misusage of the mobile phone units or to recognize successful overriding attempts of the predefined inhibit rules.

Embedded communication interfaces like Bluetooth interfaces operated as low power radio frequency interfaces can be employed additionally for data exchange between separated devices. A special kind of data exchange is broadly discussed above. If a inhibiting device according to an embodiment according to the present invention is built in a game device or connected to a game device the available low power radio frequency transceiver can be used to transceive game related data and information like score, game situation or game parameters. The parameters allow the user of a game device to transmit these data to another game device or to receive such data from another game device. Direct transceiving of the game related data is possible as also to transceive data via a mobile device like a mobile phone, mobile computer or devices in the kind of personal digital assistants (PDA) equipped with an according communication interface. Of course to transceive only game related data it is not necessary to implement a complete inhibiting device such as one of the presented embodiments. It is sufficient to implement a low power radio frequency communication interface and additional necessary units therefore in order to operate the interface.

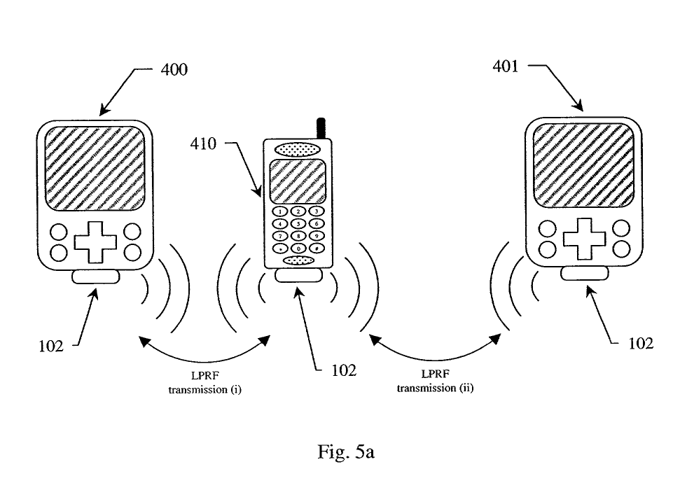

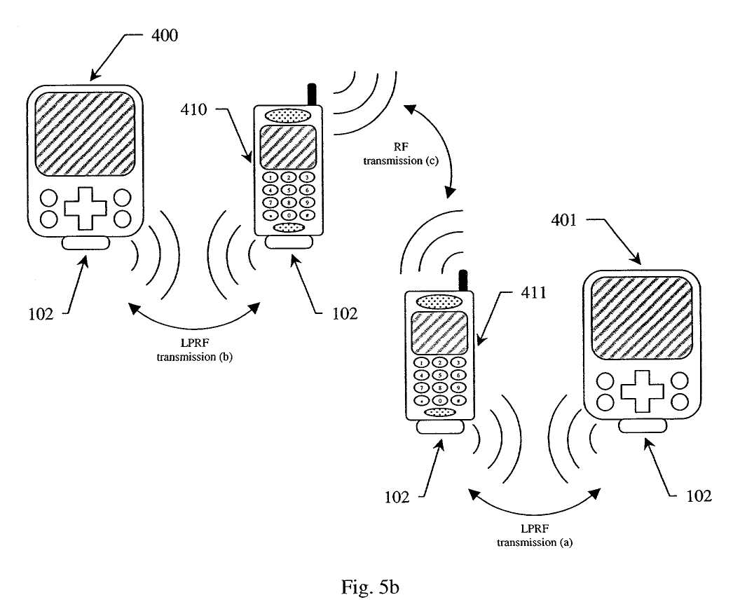

FIG. 5a shows a game device 400 and a mobile phone 410 both equipped with a Bluetooth interface 102. The game device is able to transmit and receive game related data via the Bluetooth interface 102. The game related data can be used to store a game situation using another device or to transmit or receive the game situation in order to continue playing the game on the respective game device. The mobile phone 410 serves as a receive, transmit and store unit for the game related data. For example a game situation of the game device 400 is transmitted via the Bluetooth interface 102 to the receiving mobile device 410. Thereon the game situation is stored. At a later moment the stored game situation is transmitted from the mobile phone 410 to another game device 401 via the Bluetooth interfaces 102. The game can be continued playing on the game device 401. Of course the game device 401 can be identical with the game device 400. In this case, the game related data are just stored. In particular, interesting if the game device is not able to store the game situation or can not store multiple different game situations which can be done using the presented method to transceive and store game related data.

The game related data, such as score, game situation and game parameters can be wrapped into data sequences or data records which can be handled by the involved devices. In case of using a mobile phone implemented data sequence such as SMS message or sequences according to OBEX standard vcards or related data sequences thereof can be employed. These data sequences can be transmitted via wide area communication networks as also via local area radio frequency networks, especially via a Bluetooth interface and wireless local area network interfaces (WLAN).

FIG. 5b shows an extended arrangement in comparison to FIG. 6a. Again, a game device 400 and a mobile phone 410 communicate via a low power radio frequency network, herein a network based on the Bluetooth standard. Additional, a second game device 401 and a second mobile phone 411 exchange data also via a local area radio frequency network, herein a Bluetooth interface network. The arrangement of this two combinations can exchange data via a wide area network, such as a mobile communication network according to the global system for mobile communication (GSM) standard. Transmission of game related data from game device 400 to game device 401 are performed by using the transmission capability to the mobile phone 410 via the low power radio frequency connection where data can be stored. The transmission is continued by transmitting the game related data from mobile phone 410 to mobile phone 411 via a wide area communication network where the data can be stored again. At last, the data are transmitted form the mobile phone 411 to the game device 401 via a local area radio frequency network. Of course, this transmission can be performed vice versa.

The foregoing description of the preferred embodiment of the invention has been presented to the purpose of illustrations and descriptions. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method to inhibit functions of a device by using a mobile remote control means both comprising a wireless interface, said device having a plurality of functions which are controlled by a controller, characterized by
authenticating of said mobile remote control means,
transmitting of inhibit rule data from said mobile remote control means to said device via wireless interfaces,
inhibiting certain functions of said device according to said transmitted inhibit rule data so that said functions are no longer operable by said controller.

2. The method according to claim 1, wherein said device is able to execute software programs and wherein said function comprises an executable software program or apart thereof.

3. The method according to claim 1, wherein said device comprises a content server and said mobile remote control means comprises a corresponding client.

4. The method according to claim 3, wherein said content server and client are employed for transmission of said inhibit rule data.

5. The method according to claim 3, wherein said content server uses a markup language content of type hypertext markup language (HTML) or extended hypertext markup language (XHTML) or extensible markup language (XML) or a wireless markup language (WML).

6. The method according to claim 1, wherein said wireless interface is a Bluetooth interface.

7. The method according to claim 6, wherein said device and said mobile remote control means employ hypertext transfer protocol (HTTP) over Bluetooth and/or transmission control protocol/internet protocol (TCP/IP) and/or wireless application protocol (WAP) over Bluetooth.

8. The method according to claim 1, wherein a secured communication link is established between the mobile remote control means and the device.

9. The method according to claim 6, wherein a Bluetooth link key generated from a passkey is used for authenticating the mobile remote control means.

10. The method according to claim 1, wherein said inhibit rule data comprise a predetermined access time.

11. The method according to claim 1, wherein said inhibit rule data comprise a predetermined period of time.

12. The method according to claim 1, wherein said inhibit rule data comprise a predetermined number of accesses.

13. The method according to claim 1, wherein said inhibit rule data comprise a predetermined identification and/or a predetermined classification code.

14. The method according to claim 1, wherein said inhibit rule data comprises predetermined cost information.

15. The method according to claim 1, wherein said device retransmits data concerning the use of the functions of the device.

16. The method according to claim 2, wherein said device comprises a content server and said mobile remote control means comprises a corresponding client.

17. The method according to claim 4, wherein said content server uses a markup language content of type hypertext markup language (HTML) or extended hypertext markup language (XHTML) or extensible markup language (XML) or a wireless markup language (WML).

18. The method according to claim 2, wherein said wireless interface is a Bluetooth interface.

19. The method according to claim 3, wherein said wireless interface is a Bluetooth interface.

20. The method according to claim 4, wherein said wireless interface is a Bluetooth interface.

21. The method according to claim 5, wherein said wireless interface is a Bluetooth interface.

22. The method according to claim 2, wherein a secured communication link is established between the mobile remote control means and the device.

23. The method according to claim 3, wherein a secured communication link is established between the mobile remote control means and the device.

24. The method according to claim 4, wherein a secured communication link is established between the mobile remote control means and the device.

25. The method according to claim 5, wherein a secured communication link is established between the mobile remote control means and the device.

26. The method according to claim 6, wherein a secured communication link is established between the mobile remote control means and the device.

27. The method according to claim 7, wherein a secured communication link is established between the mobile remote control means and the device.

28. The method according to claim 7, wherein a Bluetooth link key generated from a passkey is used for authenticating the mobile remote control means.

29. The method according to claim 2, wherein said inhibit rule data comprise a predetermined access time.

30. The method according to claim 3, wherein said inhibit rule data comprise a predetermined access time.

31. The method according to claim 4, wherein said inhibit rule data comprise a predetermined access time.

32. The method according to claim 5, wherein said inhibit rule data comprise a predetermined access time.

33. The method according to claim 6, wherein said inhibit rule data comprise a predetermined access time.

34. The method according to claim 7, wherein said inhibit rule data comprise a predetermined access time.

35. The method according to claim 8, wherein said inhibit rule data comprise a predetermined access time.

36. The method according to claim 9, wherein said inhibit rule data comprise a predetermined access time.

37. The method according to claim 2, wherein said inhibit rule data comprise a predetermined period of time.

38. The method according to claim 3, wherein said inhibit rule data comprise a predetermined period of time.

39. The method according to claim 4, wherein said inhibit rule data comprise a predetermined period of time.

40. The method according to claim 5, wherein said inhibit rule data comprise a predetermined period of time.

41. The method according to claim 6, wherein said inhibit rule data comprise a predetermined period of time.

42. The method according to claim 7, wherein said inhibit rule data comprise a predetermined period of time.

43. The method according to claim 8, wherein said inhibit rule data comprise a predetermined period of time.

44. The method according to claim 9, wherein said inhibit rule data comprise a predetermined period of time.

45. The method according to claim 10, wherein said inhibit rule data comprise a predetermined period of time.

46. The method according to claim 2, wherein said inhibit rule data comprise a predetermined number of accesses.

47. The method according to claim 3, wherein said inhibit rule data comprise a predetermined number of accesses.

48. The method according to claim 4, wherein said inhibit rule data comprise a predetermined number of accesses.

49. The method according to claim 5, wherein said inhibit rule data comprise a predetermined number of accesses.

50. The method according to claim 6, wherein said inhibit rule data comprise a predetermined number of accesses.

51. The method according to claim 7, wherein said inhibit rule data comprise a predetermined number of accesses.

52. The method according to claim 8, wherein said inhibit rule data comprise a predetermined number of accesses.

53. The method according to claim 9, wherein said inhibit rule data comprise a predetermined number of accesses.

54. The method according to claim 10, wherein said inhibit rule data comprise a predetermined number of accesses.

55. The method according to claim 11, wherein said inhibit rule data comprise a predetermined number of accesses.

56. The method according to claim 2, wherein said inhibit rule data comprise a predetermined identification and/or a predetermined classification code.

57. The method according to claim 3, wherein said inhibit rule data comprise a predetermined identification and/or a predetermined classification code.

58. The method according to claim 4, wherein said inhibit rule data comprise a predetermined identification and/or a predetermined classification code.

59. The method according to claim 5, wherein said inhibit rule data comprise a predetermined identification and/or a predetermined classification code.

60. The method according to claim 6, wherein said inhibit rule data comprise a predetermined identification and/or a predetermined classification code.

61. The method according to claim 7, wherein said inhibit rule data comprise a predetermined identification and/or a predetermined classification code.

62. The method according to claim 8, wherein said inhibit rule data comprise a predetermined identification and/or a predetermined classification code.

63. The method according to claim 9, wherein said inhibit rule data comprise a predetermined identification and/or a predetermined classification code.

64. The method according to claim 10, wherein said inhibit rule data comprise a predetermined identification and/or a predetermined classification code.

65. The method according to claim 11, wherein said inhibit rule data comprise a predetermined identification and/or a predetermined classification code.

66. The method according to claim 12, wherein said inhibit rule data comprise a predetermined identification and/or a predetermined classification code.

67. The method according to claim 2, wherein said inhibit rule data comprises predetermined cost information.

68. The method according to claim 3, wherein said inhibit rule data comprises predetermined cost information.

69. The method according to claim 4, wherein said inhibit rule data comprises predetermined cost information.

70. The method according to claim 5, wherein said inhibit rule data comprises predetermined cost information.

71. The method according to claim 6, wherein said inhibit rule data comprises predetermined cost information.

72. The method according to claim 7, wherein said inhibit rule data comprises predetermined cost information.

73. The method according to claim 8, wherein said inhibit rule data comprises predetermined cost information.

74. The method according to claim 9, wherein said inhibit rule data comprises predetermined cost information.

75. The method according to claim 10, wherein said inhibit rule data comprises predetermined cost information.

76. The method according to claim 11, wherein said inhibit rule data comprises predetermined cost information.

77. The method according to claim 12, wherein said inhibit rule data comprises predetermined cost information.

78. The method according to claim 13, wherein said inhibit rule data comprises predetermined cost information.

79. The method according to claim 2, wherein said device retransmits data concerning the use of the functions of the device.

80. The method according to claim 3, wherein said device retransmits data concerning the use of the functions of the device.

81. The method according to claim 4, wherein said device retransmits data concerning the use of the functions of the device.

82. The method according to claim 5, wherein said device retransmits data concerning the use of the functions of the device.

83. The method according to claim 6, wherein said device retransmits data concerning the use of the functions of the device.

84. The method according to claim 7, wherein said device retransmits data concerning the use of the functions of the device.

85. The method according to claim 8, wherein said device retransmits data concerning the use of the functions of the device.

86. The method according to claim 9, wherein said device retransmits data concerning the use of the functions of the device.

87. The method according to claim 10, wherein said device retransmits data concerning the use of the functions of the device.

88. The method according to claim 11, wherein said device retransmits data concerning the use of the functions of the device.

89. The method according to claim 12, wherein said device retransmits data concerning the use of the functions of the device.

90. The method according to claim 13, wherein said device retransmits data concerning the use of the functions of the device.

91. The method according to claim 14, wherein said device retransmits data concerning the use of the functions of the device.
